(19) United States
(12) Patent Application Publication
(10) Pub. No.: US 2015/0363047 A1
(43) Pub. Date: Dec. 17, 2015

(54) METHODS AND SYSTEMS FOR MULTIMODAL INTERACTION

(71) Applicant: ALCATEL LUCENT, Boulogne-Billancourt (FR)

(72) Inventor: Akhil Mathur, Bangalore (IN)

(73) Assignee: ALCATEL LUCENT, Boulogne Billancourt (FR)

(21) Appl. No.: 14/767,715

(22) PCT Filed: Feb. 7, 2014
(86) PCT No.: PCT/EP2014/000330

§ 371 Date: Aug. 13, 2015

(30) Foreign Application Priority Data
Feb. 14, 2013 (IN) 428/DEL/2013

(51) Int. Cl. G06F 3/0481; G06F 3/0484; G06F 3/0482

(52) U.S. Cl. CPC G06F 3/0481; G06F 3/04817; G06F 3/0482; G06F 3/04842; G06F 2203/0381

(57) ABSTRACT

Methods and systems for multimodal interaction are described herein. In one embodiment, a method for multimodal interaction comprises determining whether a first input modality is successful in providing inputs for performing a task. The method further includes prompting the user to use a second input modality to provide inputs for performing the task on determining the first input modality to be unsuccessful. Further, the method comprises receiving inputs from at least one of the first input modality and the second input modality. The method further comprises performing the task based on the inputs received from at least one of the first input modality and the second input modality.

### FIELD OF INVENTION

The present subject matter relates to computing devices and, particularly but not exclusively, to multimodal interaction techniques for computing devices.

### BACKGROUND

With advances in technology, various modalities are now being used for facilitating interactions between a user and a computing device. For instance, nowadays the computing device are provided with interfaces for supporting multimodal interactions using various input modalities, such as touch, speech, type, and click and various output modalities, such as speech, graphics, and visuals. The input modalities allow the user to interact in different ways with the computing device for providing inputs for performing a task. The output modalities allow the computing device to provide an output in various forms in response to the performance or non-performance of the task. In order to interact with the computing devices the user may use any of the input and output modalities, supported by the computing devices, based on their preferences or comfort. For instance, one user may use the speech or the type modality for searching a name in a contact list, while another user may use the touch or click modality for scrolling through the contact list.

### SUMMARY

This summary is provided to introduce concepts related to systems and methods for multimodal interaction. This summary is not intended to identify essential features of the claimed subject matter nor is it intended for use in determining or limiting the scope of the claimed subject matter.

In one implementation, a method for multimodal interaction is described. The method includes receiving an input from a user through a first input modality for performing a task. Upon receiving the input it is determined whether the first input modality is successful in providing inputs for performing the task. The determination includes ascertaining whether the input is executable for performing the task. Further, the determination includes increasing value of an error count by one if the input is non-executable for performing the task, where the error count is a count of the number of inputs received from the first input modality for performing the task. Further, the determination includes comparing the error count with a threshold value. Further, the first input modality is determined to be unsuccessful if the error count is greater than the threshold value. The method further includes prompting the user to use a second input modality to provide inputs for performing the task on determining the first input modality to be unsuccessful. Further, the method comprises receiving inputs from at least one of the first input modality and the second input modality. The method further comprises performing the task based on the inputs received from at least one of the first input modality and the second input modality.

In another implementation, a computer program adapted to perform the methods in accordance to the previous implementation is described.

In yet another implementation, a computer program product comprising a computer readable medium, having thereon a computer program comprising program instructions is described. The computer program is loadable into a data-processing unit and adapted to cause execution of the method in accordance to the previous implementation.

In yet another implementation, a multimodal interaction system is described. The multimodal interaction system is configured to determine whether a first input modality is successful in providing inputs for performing a task. The multimodal interaction system is further configured to prompt the user to use a second input modality to provide inputs for performing the task when the first input modality is unsuccessful. Further, the multimodal interaction system is configured to receive the inputs from at least one of the first input modality and the second input modality. The multimodal interaction system is further configured to perform the task based on the inputs received from at least one of the first input modality and the second input modality.

In yet another implementation, a computing system comprising the multimodal interaction system is described. The computing system is at least one of a desktop computer, a hand-held device, a multiprocessor system, a personal digital assistant, a mobile phone, a laptop, a network computer, a cloud server, a minicomputer, a mainframe computer, a touch-enabled camera, and an interactive gaming console.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a multimodal interaction system, according to an embodiment of the present subject matter.

FIG. 2(a) illustrates a screen shot of a map application being used by a user for searching a location using a first input modality, according to an embodiment of the present subject matter.

FIG. 2(b) illustrates a screen shot of the map application with a prompt generated by the multimodal input modality for indicating the user to use a second input modality, according to an embodiment of the present subject matter.

FIG. 2(c) illustrates a screen shot of the map application indicating successful determination of the using the inputs received from the first input modality and the second input modality, according to another embodiment of the present subject matter.

FIG. 3 illustrates a method for multimodal interaction, according to an embodiment of the present subject matter.

FIG. 4 illustrates a method for determining success of an input modality, according to an embodiment of the present subject matter.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for multimodal interaction are described. Computing devices nowadays typically include various input and output modalities for facilitating interactions between a user and the computing devices. For instance, a user may interact with the computing devices using any one of an input modality, such as touch, speech, gesture, click, type, tilt, and gaze. Providing the various input modalities facilitates the interaction in cases where one of the input modalities may malfunction or may not be efficient for use. For instance, speech inputs are typically prone to recognition errors due to different accents of users, specially in cases of regional languages, and thus may be less preferred as compared to touch input for some applications. The touch or click input, on the other hand, may be tedious for a user in case repetitive touches or clicks are required.

Conventional systems typically implement multimodal interaction techniques that integrate multiple input modalities into a single interface thus allowing the users to use various input modalities in a single application. One of such conventional systems uses a “put-that-there” technique according to which the computing system allows a user to use different input modalities for performing different actions of a task. For instance, a task involving moving a folder to a new location may be performed by the user using three actions. The first action being speaking the word “move”, the second action being touching the folder to be moved, and the third action being touching the new location on the computing system's screen for moving the folder. Although the above technique allows the user to use different input modalities for performing different actions of a single task, each action is in itself performed using a single input modality. For instance, the user may use only one of the speech or the touch for performing the action of selecting the new location. Malfunctioning or difficulty in usage of the input modality used for performing a particular action may thus affect the performance of the entire task. The conventional systems thus either force the users to interact using a particular modality, or choose from input modalities pre-determined by the systems.

According to an implementation of the present subject matter, systems and methods for multimodal interaction are described. The systems and the methods can be implemented in a variety of computing devices, such as a desktop computer, hand-held device, cloud servers, mainframe computers, workstation, a multiprocessor system, a hand-held device, a personal digital assistant (PDA), a smart phone, a laptop computer, a network computer, a minicomputer, a server, and the like.

In accordance with an embodiment of the present subject matter, the system allows the user to use multiple input modalities for performing a task. In said embodiment, the system is configured to determine if the user is able to effectively use a particular input modality for performing the task. In case the user is not able to sufficiently use the particular input modality, the system may suggest that the user use another input modality for performing the task. The user may then use either both the input modalities or any one of the input modalities for performing the task. Thus, the task may be performed efficiently and in time even if one of the input modalities malfunctions or is not able to provide satisfactory inputs to the system.

In one embodiment, the user may initially give inputs for performing a task using a first input modality, say, speech. For the purpose, the user may initiate an application for performing the task and subsequently select the first input modality for providing the input. The user may then provide the input to the system using the first input modality for performing the task. Upon receiving the input, the system may begin processing the input to obtain commands given by the user for performing the task. In case the inputs provided by the user are executable, the system may determine the first input modality to be working satisfactorily and continue receiving the inputs from the first input modality. For instance, in case the system determines that the speech input provided by the user is successfully converted by a speech recognition engine, the system may determine the input modality to be working satisfactorily.

In case the system determines the first input modality to be unsuccessful, i.e., working non-satisfactorily, the system may prompt the user to use a second input modality. In one implementation, the system may determine the first input modality to be unsuccessful when the system is not able to process the inputs for execution. For example, when the system is not able to recognize the speech. In another implementation, the system may determine the first input modality to be unsuccessful when the system receives inputs multiple times for performing the same task. In such a case the system may determine whether the number of inputs are more than a threshold value and ascertain the input modality to be unsuccessful when the number of inputs are more than the threshold value. For instance, in case of the speech modality the system may determine the first input modality to be unsuccessful in case the user provides the speech input for more number of times than a threshold value, say, 3 times. Similarly, tapping of the screen for more number of times than the threshold value may make the system ascertain the touch modality as unsuccessful. On determining the first input modality to be unsuccessful, the system may prompt the user to use the second input modality.

In one implementation, the system may determine the second input modality based on various predefined rules. For example, the system may ascertain the second input modality based on a predetermined order of using input modalities. In another example, the system may ascertain the second input modality randomly from the available input modalities. In yet another example, the system may ascertain the second input modality based on the type of the first input modality. For example, in a desktop system, touch and click or scroll by mouse can be classified as ‘Scroll’ modalities, while type through a physical keyboard and a virtual keyboard can be classified as ‘Typing’ modalities. In case touch, i.e., a scroll modality is not performing well as the first input modality, the system may introduce a modality from another type, such as ‘typing’ as the second input modality. In yet another example, the system may provide a list of input modalities, along with the prompt, from which the user may select the second input modality. Upon receiving the prompt, the user may either use the second input modality or continue using the first input modality to provide the inputs for performing the task. Further, the user may choose to use both the first input modality and the second input modality for providing the inputs to the system. In case the user wishes to use both the input modalities, the input modalities may be simultaneously used by the user for providing inputs to the system for performing the task. The inputs thus provided by the user through the different input modalities may be simultaneously processed by the system for execution.

For instance, while searching a place in a map, the user may initially use the touch input modality to touch on the screen and search for the place. In case the user is not able to locate the place after a predetermined number of touches, the system may determine the touch input modality to be unsuccessful and prompt the user to use another input modality, say, the speech. The user may now either use any of the touch and speech modality or use both the speech and the type modality to ask the system to locate the particular place on the map. The system, on receiving inputs from both the input modalities, may start processing the inputs to identify the command given by the user and execute the commands upon being processed. In case the system is not able to process inputs given by any one of the input modalities, it may still be able to locate the particular location on the map using the commands obtained by processing the input from the other input modality. The system thus allows the user to use various input modalities for performing a single task.

The present subject matter thus facilitates the user to use multiple input modalities for performing a task. Suggesting the user to use an alternate input modality upon not being able to successfully use an input modality helps the user in saving the time and efforts in performing the task. Further, suggesting the alternate input modality may also help reduce a user's frustration of using a particular input modality like speech in situations where the computing device is not able to recognize the user's speech for various reasons, say, different accent or background noise. Providing the alternate input modality may thus help the user in completing the task. Further, prompting the user may help in applications where the user is not able to go back to a home page for selecting an alternate input modality as in such a case the user may use the prompt to select the alternate or additional input modality without having to leave the current screen. The present subject matter may further help users having disability, such as disabilities in speaking, stammering, non-fluency in speaking any language, weak eye sight, and neurological disorders causing shaking of hands as the system readily suggests usage of a second input modality upon detecting the user's difficulty in providing the input through the first input modality. Thus, while typing a message on a touch screen phone, if the user is not able to type due to shaking of hands, the user may suggest usage of another input modality, say, speech, thus facilitating the user in typing the message.

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the words “connected” and “coupled” are used throughout for clarity of the description and can include either a direct connection or an indirect connection.

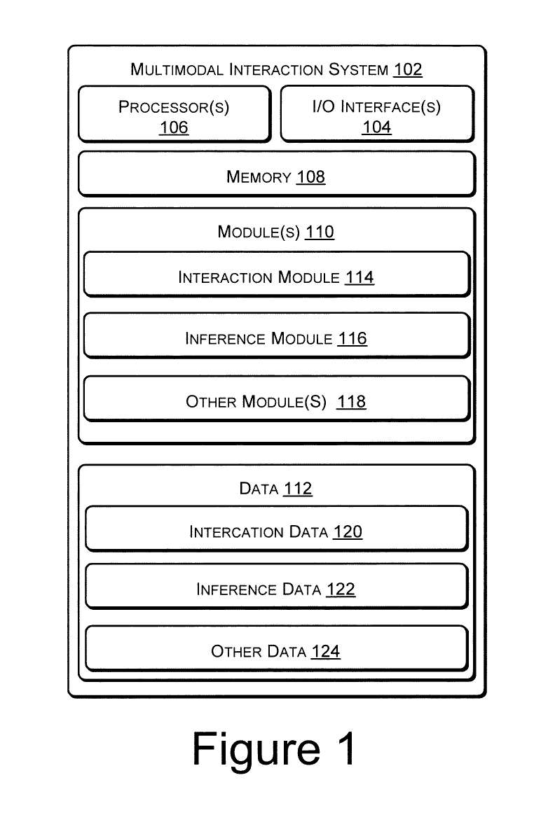

The manner in which the systems and the methods of multimodal interaction may be implemented has been explained in details with respect to the FIGS. 1 to 4. While aspects of described systems and methods for multimodal interaction can be implemented in any number of different computing systems, transmission environments, and/or configurations, the embodiments are described in the context of the following exemplary system(s).

FIG. 1 illustrates a multimodal interaction system 102 according to an embodiment of the present subject matter. The multimodal interaction system 102 can be implemented in computing systems that include, but are not limited to, desktop computers, hand-held devices, multiprocessor systems, personal digital assistants (PDAs), laptops, network computers, cloud servers, minicomputers, mainframe computers, interactive gaming consoles, mobile phones, a touch-enabled camera, and the like. In one implementation, the multimodal interaction system 102, hereinafter referred to as the system 102, includes I/O interface(s) 104, one or more processor(s) 106, and a memory 108 coupled to the processor(s) 106.

The interfaces 104 may include a variety of software and hardware interfaces, for example, interfaces for peripheral device(s), such as a keyboard, a mouse, an external memory, and a printer. Further, the interfaces 104 may enable the system 102 to communicate with other devices, such as web servers and external databases. For the purpose, the interfaces 104 may include one or more ports for connecting a number of computing systems with one another or to another server computer. The interfaces 104 may further allow the system 102 to interact with one or more users through various input and output modalities, such as a keyboard, a touch screen, a microphone, a speaker, a camera, a touchpad, a joystick, a trackball, and a display.

The processor 106 can be a single processing unit or a number of units, all of which could also include multiple computing units. The processor 106 may be implemented as one or more microprocessors, microcomputers, microcontrollers, digital signal processors, central processing units, state machines, logic circuitries, and/or any devices that manipulate signals based on operational instructions. Among other capabilities, the processor 106 is configured to fetch and execute computer-readable instructions and data stored in the memory 108.

The functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, network processor, application specific integrated circuit (ASIC), field programmable gate array (FPGA), read only memory (ROM) for storing software, random access memory (RAM), and non volatile storage. Other hardware, conventional and/or custom, may also be included.

The memory 108 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the system 102 includes module(s) 110 and data 112. The module(s) 110, amongst other things, include routines, programs, objects, components, data structures, etc., which perform particular tasks or implement particular abstract data types. The module(s) 110 may also be implemented as, signal processor(s), state machine(s), logic circuitries, and/or any other device or component that manipulate signals based on operational instructions.

Further, the module(s) 110 can be implemented in hardware, instructions executed by a processing unit, or by a combination thereof. The processing unit can comprise a computer, a processor, such as the processor 106, a state machine, a logic array, or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 110 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The module(s) 110 further include an interaction module 114, an inference module 116, and other modules 118. The other module(s) 118 may include programs or coded instructions that supplement applications and functions of the system 102. The data 112, amongst other things, serves as a repository for storing data processed, received, associated, and generated by one or more of the module(s) 110. The data 112 includes, for example, interaction data 120, inference data 122, and other data 124. The other data 124 includes data generated as a result of the execution of one or more modules in the other module(s) 118.

As previously described, the system 102 is configured to interact with a user through various input and output modalities. Examples of the output modalities include, but are not limited to, speech, graphics, and visuals. Examples of the input modalities include, but are not limited to, such as touch, speech, type, click, gesture, and gaze. The user may use any one of the input modalities to give inputs for interacting with the system 102. For instance, the user may provide an input to a user by touching a display of the screen, by giving an oral command using a microphone, by giving a written command using a keyboard, by clicking or scrolling using a mouse or joystick, by making gestures in front of the system 102, or by gazing at a camera attached to the system 102. In one implementation, the user may use the input modalities to give inputs to the system 102 for performing a task.

In accordance with an embodiment of the present subject matter, the interaction module 114 is configured to receive the inputs, through any of the input modalities, from the user and provide outputs, through any of the output modalities, to the user. In order to perform the task, the user may initially select an input modality for providing the inputs to the interaction module 114. In one implementation, the interaction module 114 may provide a list of available input modalities to the user for selecting an appropriate input modality. The user may subsequently select a first input modality from the available input modalities based on various factors, such as user's comfort or the user's previous experience of performing the task using a particular input modality. For example, while using a map a user may use the touch modality, whereas for preparing a document the user may use the type or the click modality. Similarly for searching a contact number the user may use the speech modality, while for playing games the user may use the gesture modality.

Upon selecting the first input modality, the user may provide the input for performing the task. In another implementation, the user may directly start using the first input modality without selection, for providing the inputs. In one implementation, the input may include commands provided by the user for performing the task. For instance, in case of the input modality being speech, the user may speak into the microphone (not shown in the figure) connected to or integrated within the system 102 to provide an input having commands for performing the task. On detecting an audio input, the interaction module 114 may indicate the inference module 116 to initiate processing the input to determine the command given by the user. For example, while searching for a location in a map, the user may speak the name of the location and ask the system 102 to search for the location. Upon receiving the speech input, the interaction module 114 may indicate the inference module 116 to initiate processing the input to determine the name of location to be searched by the user. It will be understood by a person skilled in the art that speaking the name of the place while using a map application indicates the inference module 116 to search for the location in the map.

Upon receiving the input, the interaction module 114 may initially save the input in the interaction data 120 for further processing by the inference module 116. The inference module 116 may subsequently initiate processing the input to determine the command given by the user. In case the inference module 116 is able to process the input for execution, the inference module 116 may determine the first input modality to be successful and execute the command to perform the required task. In case the task is correctly performed, the user may either continue working using the output received after the performance of the task or initiate another task. For instance, in the above example of speech input for searching the location in the map, the inference module 116 may process the input using a speech recognition engine to determine the location provided by the user. In case the inference module 116 is able to determine the location, it may execute the user's command to search for the location in order to perform the task of location search. In case the location identified by the inference module 116 is correct, the user may continue using the identified location for other tasks, say, determining driving directions to the place.

However, in case the inference module 116 is either not able to execute the command to perform the task or is not able to correctly perform the task; the inference module 116 may determine whether the first input modality is unsuccessful. In one implementation, the inference module 116 may determine the first input modality to be unsuccessful if the input from the first input modality has been received for more than a threshold number of times. For the purpose, the inference module 116 may increase the value of an error count, i.e., a count of number of times the input has been received from the first input modality. The inference module 116 may increase the value of the error count each time it is not able to perform the task based on the input from the first input modality. For instance, in the previous example of speech input for searching the location, the inference modality 116 may increase the error count upon failing to locate the location on the map based on the user's input. For example, the inference module 116 may increase the error count in case either the speech recognition engine is not able to recognize speech or the recognized speech can't be used by the inference module 116 to determine the name of a valid location. In another example, the inference module 116 may increase the error count in case the location determined by the inference module 116 is not correct and the user still continues searching for the location. In one implementation, the inference module 116 may save the value of the error count in the inference data 122.

Further, the inference module 116 may determine whether the error count is greater than a threshold value, say, 3, 4, or 5 number of inputs. In one implementation, the threshold value may be preset in the system 102 by a manufacturer of the system 102. In another implementation, threshold value may be set by a user of the system 102. In yet another implementation, the threshold value may be dynamically set by the inference module 116. For example, in case of the speech modality, the inference module 116 may dynamically set the threshold value as one if no input is received by the interaction module 114, for example, when the microphone has been disabled. However, in case some input is received by the interaction module 114, the threshold value may be set using the preset values.

Further, in one implementation, the threshold values may be set different for different input modalities. In another implementation, the same threshold value may be set for all the input modalities. In case the error count is greater than the threshold value the inference module 116 may determine the first input modality to be unsuccessful and suggest the user to use a second input modality. In accordance with the above embodiment, the inference module 116 may be configured to determine the success of the first input modality using the following pseudo code:

error count = 0;
if [recognition_results] contain ‘desired output’
return SUCCESSFUL;
if [recognition_results] = = null
error count ++;
else if [recognition_results] do not contain ‘desired output’
error count ++;
if error count > threshold value
return UNSUCCESSFUL;

In one embodiment, the inference module 116 may determine the second input modality based on various predefined rules. In one implementation the inference module 116 may ascertain the second input modality based on a predetermined order of using input modalities. For example, for a touch-screen phone, the predetermined order might be touch>speech>type>tilt. Thus, if the first input modality is speech, the inference module 116 may select touch as the second input modality due to its precedence in the list. However, if neither speech nor touch is able to perform the task, the inference module 116 may introduce type as a tertiary input modality and so on. In one implementation, the predetermined order may be preset by a manufacturer of the system 102. In another implementation, the predetermined order may be set by a user of the system 102.

In another implementation, the inference module 116 may determine the second input modality randomly from the available input modalities. In yet another implementation, the inference module 116 may ascertain the second input modality based on the type of the first input modality. For example, in a desktop system, touch and click or scroll by mouse can be classified as scroll modalities; type through a physical keyboard and a virtual keyboard can be classified as typing modalities; speech can be a third type of modality. In case touch, i.e., a scroll modality is not performing well as the first input modality, the inference module 116 may introduce a modality from another type, such as typing or speech as the second input modality. Further, among the similar types, the inference module 116 may select an input modality either randomly or based on the predetermined order. In yet another implementation, the inference module 116 may generate a pop-up with names of the available input modalities and ask the user to choose any one of the input modalities as the second input modality. Based on the user preference, the inference module 116 may initiate the second input modality.

Upon determination, the inference module 116 may prompt the user to use the second input modality. In one implementation the inference module 116 may prompt the user by flashing the name of the second input modality. In another implementation, the inference module 116 may flash an icon indicating the second input modality. For instance, in the previous example of speech input for searching the location in the map, the inference module 116 may determine the touch input as the second input modality and either flash the text “tap on map” or show an icon having a hand with a finger pointing out indicating the use of touch input. Upon seeing the prompts, the user may choose to use either of the first and the second input modality for performing the task. The user in such a case may provide the inputs to the interaction module 114 using the selected input modality.

Upon receiving the prompt, the user may either use the second input modality or continue using the first input modality to provide the inputs for performing the task. Further, the user may choose to use both the first input modality and the second input modality for providing the inputs to the system. In case the user wishes to use both the input modalities, the input modalities may be simultaneously used by the user for providing inputs to the system 102 for performing the task. The inputs thus provided by the user through the different input modalities may be simultaneously processed by the system 102 for execution. Alternately, the user may provide inputs using the first and the second input modality one after the other. In such a case the inference module 116 may process both the inputs and perform the task using the inputs independently. In case input received from only one of the first and the second input modality is executable, the inference module 116 may perform the task using that input. Thus, the task may be performed efficiently and in time even if one of the input modalities malfunctions or is not able to provide satisfactory inputs. Further, in case inputs from both the first and the second input modality are executable, the user may use the output from the input which is first executed.

For instance, in the previous example of speech being the first input modality and touch being the second input modality, the user may use either one of speech and touch or both speech and touch for searching the location on the map. If the user uses only one of the speech and text for giving inputs, the inference module 116 may use the input for determining the location. If the user gives inputs using both touch and speech, the inference module 116 may process both the inputs for determining the location. In case both the inputs are executable, the inference module 116 may start locating the location using both the inputs separately. Once located, the interaction module 114 may provide the location to the person based on the input which is executed first.

In another example, if a user wants to select an item in a long list of items, say, 100 items, the user may initially use the touch as the first input modality to scroll down the list. In case the item the user is trying to search is at the end of the list, the user may need to perform multiple scrolling (touch) gestures to reach to the item. However, as the number of the user's touch cross the threshold value, say, three scroll gestures, the inference module 116 may determine the first input modality to be unsuccessful and prompt the user to use a second input modality, say, speech. The user may subsequently either use one of the speech and touch or both the speech and touch inputs to search the item in the list. For instance, on deciding to use the speech modality, the user may speak the name of the intended item in the list. The inference module 116 may subsequently look for the item in the list and if the item is found, the list scrolls to the intended item. Further, even if the speech input fails to give the correct output, the user may still use touch gestures to scroll in the list.

In another example, if a user wants to delete text inside a document, the user may initially use click of the backspace button on the keyboard as the first input modality to delete the text. In case the text the user is trying to delete is a long paragraph, the user may need to press the backspace button multiple times to delete the text. However, as the number of the click of the backspace button crosses the threshold value, say, five clicks, the inference module 116 may determine the first input modality to be unsuccessful and prompt the user to use a second input modality, say, speech. The user may subsequently either use one of the speech and click or both the speech and click inputs to delete the text. For instance, on deciding to use the speech modality, the user may speak a command, say, “delete paragraph” based on which the inference module 116 may delete the text. Further, even if the speech input fails to delete the text correctly, the user may still use the backspace button to delete the text.

In another example, if a user wants to resize an image to adjust the height of the image to 250 pixels, the user may initially use click and drag of a mouse as the first input modality to stretch or squeeze the image. However, owing to the preciseness required in the adjustment process, the user may need to use the mouse click and drag multiple times to set the image to 250 pixels. However, as the number of the click and drag crosses the threshold value, say, 4 clicks, the inference module 116 may determine the first input modality to be unsuccessful and prompt the user to use a second input modality, say, text. The user may subsequently either use one of the text and click or both the text and click inputs to resize the image. For instance, on deciding to use the text modality, the user may type the text “250 pixels” in a textbox, based on which the inference module 116 may resize the image. Further, even if the text input fails to resize the image correctly, the user may still use the mouse.

Further, in case both the first and the second input modality are determined as unsuccessful, the inference module 116 may prompt for use of a third input modality and so on until the task is completed.

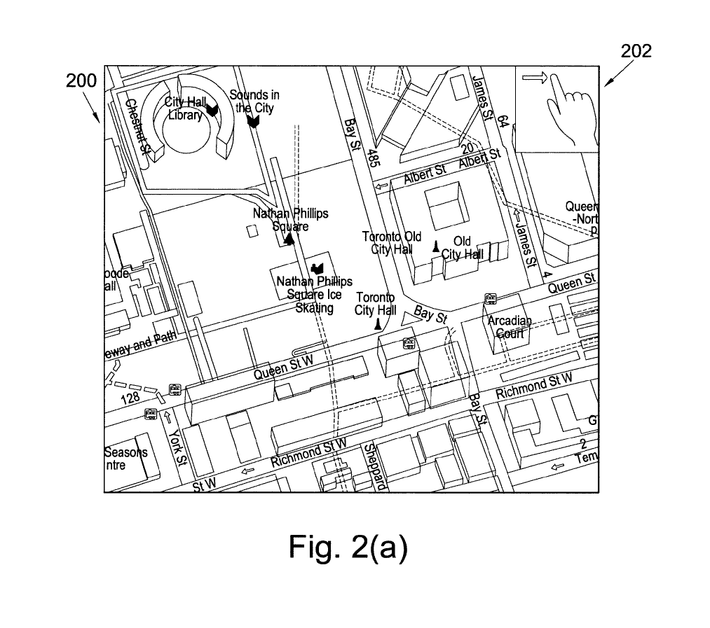

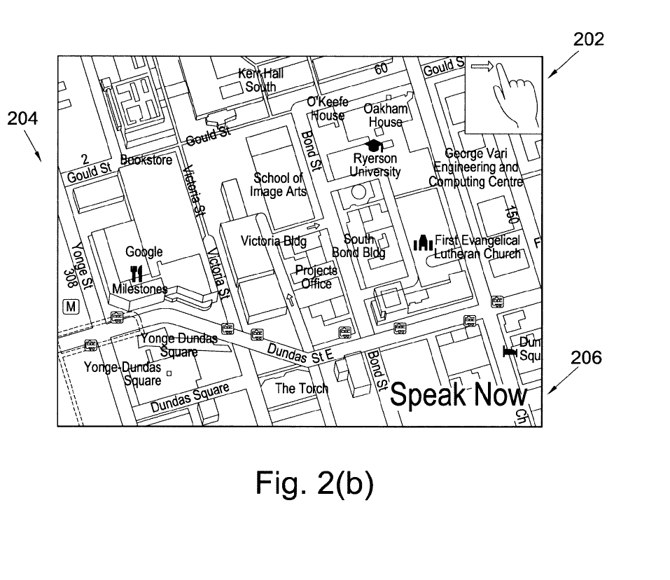

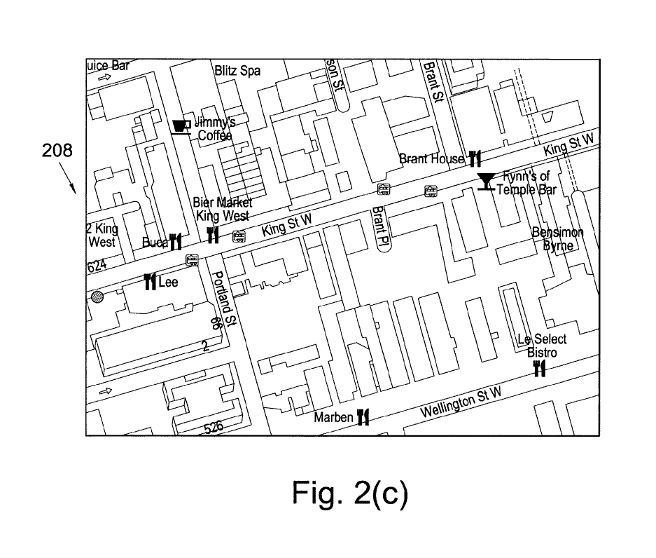

FIG. 2(a) illustrates a screen shot 200 of a map application being used by a user for searching a location using a first input modality, according to an embodiment of the present subject matter. As indicated by an arrow 202 in the top most right corner of the map, the user is initially trying to search the location using the touch as the first input modality. The user may thus tap the on a touch interface (not shown in the figure), for example, a display screen of the system 102 to provide the input to the system 102. In case the inference module 116 is not able to determine the location based on the tap, for example, owing to failure to infer the tap, the inference module 116 may determine if the error count is greater than the threshold value. On determining the error count to be greater than the threshold value, the inference module 116 may determine the touch modality to be unsuccessful and prompt the user to use a second input modality as illustrated in FIG. 2(b).

FIG. 2(b) illustrates a screen shot 204 of the map application with a prompt generated by the multimodal input modality for indicating the user to use the second input modality, according to an embodiment of the present subject matter. As illustrated, the inference module 116 generates a prompt “speak now”, as indicated by an arrow 206. The prompt indicates the user to use speech as the second modality for searching the location in the map.

FIG. 2(c) illustrates a screen shot 208 of the map application indicating successful determination of the location using at least one of the inputs received from the first input modality and the second input modality, according to another embodiment of the present subject matter. As illustrated, the inference module 116 displays the location in the map based on the inputs provided by the user.

Although FIGS. 1, 2(a), 2(b), and 2(c) have been described in relation to touch and speech modalities used for searching a location in a map, the system 102 can be used for other input modalities as well, albeit with few modifications as will be understood by a person skilled in the art. Further, as previously described, the inference module 116 may provide options of using additional input modalities if even the second input modality fails to perform the task. The inference module 116 may keep on providing such options if the task is not performed until all the input modalities have been used by the user.

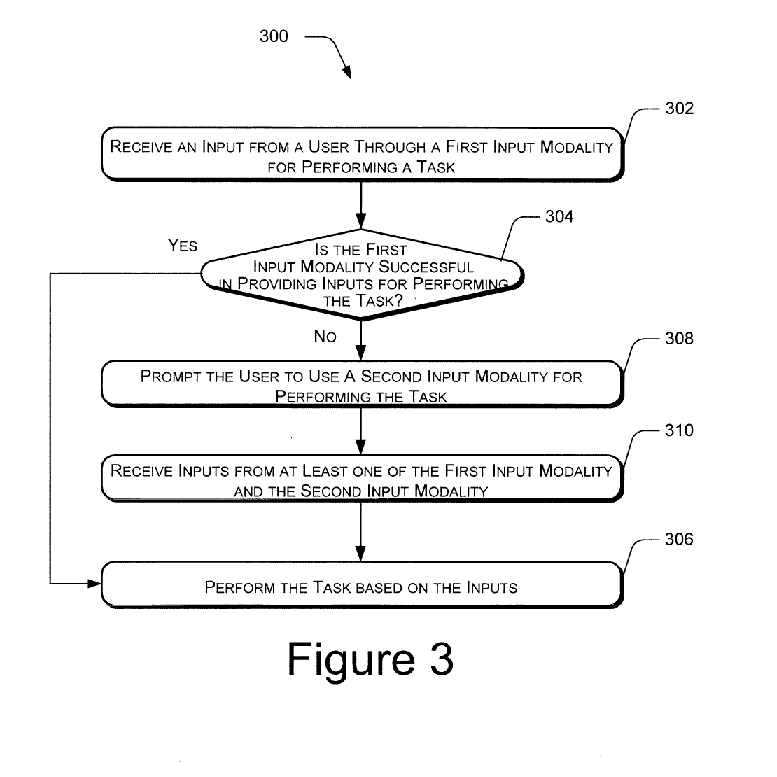

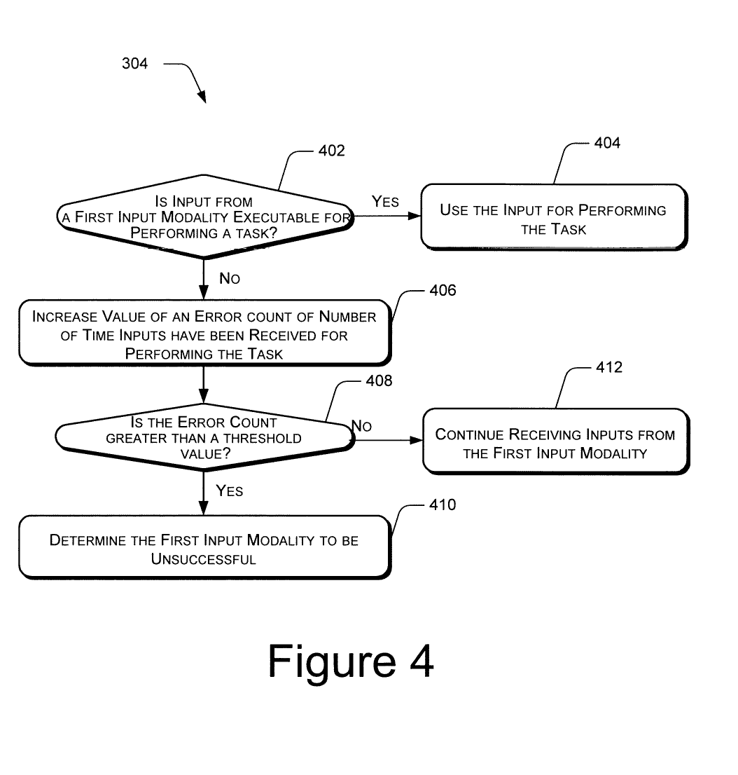

FIGS. 3 and 4 illustrate a method 300 and a method 304, respectively, for multimodal interaction, according to an embodiment of the present subject matter. The order in which the method is described is not intended to be construed as a limitation, and any number of the described method blocks can be combined in any order to implement the methods 300 and 304 or any alternative methods. Additionally, individual blocks may be deleted from the methods without departing from the spirit and scope of the subject matter described herein. Furthermore, the method(s) can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) 300 and 304 can be performed by programmed computers. Herein, some embodiments are also intended to cover program storage devices or computer readable medium, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary method(s).

FIG. 3 illustrates the method 300 for multimodal interaction, according to an embodiment of the present subject matter.

At block 302, an input for performing a task is received from a user through a first input modality. In one implementation, the user may provide the input using a first input modality selected from among a plurality of input modalities for performing the task. An interaction module, say, the interaction module 114 of the system 102 may be configured to subsequently receive the input from the user and initiate the processing of the input for performing the task. For example, while browsing through a directory of games of a gaming console a user may select gesture modality as the first input modality from among a plurality of input modalities, such as speech, type, and click. Using the gesture modality the user may give an input for toggling through pages of the directory using by moving his hands in the direction the user wants to toggle the pages to. For example, for moving to a next page the user may move his hand in right direction from a central axis, while for moving to a previous page the user may move his hand in left direction from the central axis. Thus based on the movement of the user's hand, the interaction module may infer the input and save the same in the interaction data 120.

At block 304, a determination is made to ascertain whether the first input modality is successful or not. For instance, the input is processed to determine if the first input can be successfully used for performing the task. If an inference module, say, the inference module 116 determines that the first input modality is successful, which is the ‘Yes’ path from the block 304, the task is performed at the block 306. For instance, in the previous, example of using gestures for toggling the pages, the inference module 116 may turn the pages if it is able to infer the user's gesture.

In case at block 304 it is determined that the first input modality is unsuccessful, which is the ‘No’ path from the block 304, a prompt suggesting the user to use a second input modality is generated at block 308. For example, the inference module 116 may generate a prompting indicating the second input modality that the user may use either alone or along with the first input modality to give inputs for performing the task. In one implementation, the inference module 116 may initially determine the second input modality from among the plurality of input modalities. For example, the inference module 116 may randomly determine the second input modality from among the plurality of input modalities.

In another example, the inference module 116 may ascertain the second input modality based on a predetermined order of using input modalities. For instance, in the above example of the gaming console, the predetermined order might be gesture>speech>click. Thus, if the first input modality is gesture the inference module 116 may select speech as the second input modality. In case neither speech nor gesture is able to perform the task, the inference module 116 may introduce click as the tertiary input modality. In one implementation, the predetermined order may be preset by a manufacturer of the system 102.

In another implementation, the predetermined order may be set by a user of the system 102.

In yet another example, the inference module 116 may ascertain the second input modality based on the type of the first input modality. In case modality of a particular type is not performing well as the first input modality, the inference module 116 may introduce a modality from another type as the second input modality. Further, among the similar types, the inference module 116 may select an input modality either randomly or based on the predetermined order. In yet another example, the inference module 116 may generate a pop-up with a list of the available input modalities and ask the user to choose any one of the input modalities as the second input modality.

At block 310, inputs from at least one of the first input modality and the second input modality are received. In one implementation, the user may provide inputs using either of the first input modality and the second input modality in order to perform the task. In another implementation, the user may provide inputs using both the first input modality and the second input modality simultaneously. The interaction module 114 in both the cases may save the inputs in the interaction data 120. The inputs may further be used by the inference module 116 to perform the task at the block 310.

Although FIG. 3 has been described with reference to two input modalities, it will be appreciated by a person skilled in the art that the method may be used for suggesting more number of input modalities, until all the input modalities have been used by the user, if the task is not performed.

FIG. 4 illustrates the method 304 for determining success of an input modality, according to an embodiment of the present subject matter.

At block 402, a determination is made to ascertain whether an input received from a first input modality is executable for performing a task. For instance, the input is processed to determine if the first input can be successfully used for performing the task. If the inference module 116 determines that the first input modality is executable for performing the task, which is the ‘Yes’ path from the block 402, the task is provided at the block 404 for being used for performing task at block 306 as described with description of the FIG. 3. For instance, in the previous example of using gestures for toggling the pages, the inference module 116 may provide its inference of the user's gesture for turning the pages if it is able to infer the user's gesture at the block 402.

In case at block 402 it is determined that the input received from the first input modality is not executable, which is the ‘No’ path from the block 402, value of an error count, i.e., a count of number of time inputs have been received from the first input modality for performing the task is increased by a value of one at block 406.

At block 408, a determination is made to ascertain whether the error count is greater than a threshold value. For instance, the inference module 116 may compare the value of the error count with a threshold value, say, 3, 4, 5, or, 6 predetermined by the system 102 or a user of the system 102. If the inference module 116 determines that the error count is greater than the threshold value, which is the ‘Yes’ path from the block 408, the first input modality is being determined as unsuccessful at block 410. In case at block 408 it is determined that the error count is less than the threshold value, which is the ‘No’ path from the block 410, the inference module 116 determines the first input modality to be neither successful nor unsuccessful and the system 102 continues receiving inputs from the user at block 412.

Although embodiments for multimodal interaction have been described in a language specific to structural features and/or method(s), it is to be understood that the invention is not necessarily limited to the specific features or method(s) described. Rather, the specific features and methods are disclosed as exemplary embodiments for multimodal interaction.

1. A method for multimodal interaction comprising:
determining whether a first input modality is successful in providing inputs for performing a task;
prompting the user to use a second input modality to provide the inputs for performing the task when the first input modality is unsuccessful;
receiving the inputs from at least one of the first input modality and the second input modality; and
performing the task based on the inputs received from at least one of the first input modality and the second input modality.

2. The method as claimed in claim 1, wherein the determining comprises:
receiving, through the first input modality, the input from the user for performing the task;
determining whether the input is executable for performing the task;
increasing a value of an error count by one for the input being non-executable for performing the task, wherein the error count is a count of a number of inputs received from the first input modality for performing the task;
comparing the error count with a threshold value; and
determining the first input modality to be unsuccessful for the error count being greater than the threshold value.

3. The method as claimed in claim 1, wherein the determining comprises:
receiving, through the first input modality, the input from a user for performing the task;
ascertaining whether the input is executable for performing the task; and
determining the first input modality to be successful for the input being executable for performing the task.

4. The method as claimed in claim 1 further comprises selecting an input modality from among a plurality of input modalities as the second input modality based on predefined rules.

5. The method as claimed in claim 4, wherein the predefined rules include at least one of a predetermined order of using input modalities, random selection of the second input modality from among the plurality of input modalities, and ascertaining the second input modality based on the type of the first input modality.

6. The method as claimed in claim 1, wherein the prompting the user to use the second input modality further comprises providing a list of input modalities to allow the user to select the second input modality.

7. A multimodal interaction system configured to:
determine whether a first input modality is successful in providing inputs for performing a task;
prompt the user to use a second input modality to provide the inputs for performing the task when the first input modality is unsuccessful;
receive the inputs from at least one of the first input modality and the second input modality; and
perform the task based on the inputs received from at least one of the first input modality and the second input modality.

8. The multimodal interaction system as claimed in claim 7, wherein the multimodal interaction system is further configured to:
receive, through the first input modality, the input from the user for performing the task;
determine whether the input is executable for performing the task;
increase a value of an error count by one for the input being non-executable for performing the task, wherein the error count is a count of a number of inputs received from the first input modality for performing the task;
compare the error count with a threshold value; and
determine the first input modality to be unsuccessful for the error count being greater than the threshold value.

9. The multimodal interaction system as claimed in claim 7, wherein the multimodal interaction system is further configured to:
receive, through the first input modality, the input from a user for performing the task;
ascertain whether the input is executable for performing the task; and
determine the first input modality to be successful for the input being executable for performing the task.

10. The multimodal interaction system as claimed in claim 7, wherein the multimodal interaction system is further configured to select an input modality from among a plurality of input modalities as the second input modality based on predefined rules.

11. The multimodal interaction system as claimed in claim 10, wherein the predefined rules include at least one of a predetermined order of using input modalities, random selection of the second input modality from among the plurality of input modalities, and ascertaining the second input modality based on the type of the first input modality.

12. The multimodal interaction system as claimed in claim 7, wherein the multimodal interaction system is further configured to provide a list of input modalities to allow the user to select the second input modality.

13. The multimodal interaction system as claimed in claim 7, wherein the multimodal interaction system is further configured to display at least one of a name of the second input modality and an icon indicating the second input modality to prompt the user to use the second input modality.

14. The multimodal interaction system as claimed in claim 7, wherein the multimodal interaction system comprises:
a processor;
an interaction module coupled to the processor, the interaction module configured to:
receive the inputs from at least one of the first input modality and the second input modality;
an inference module coupled to the processor, the inference module configured to:
determine whether a first input modality is successful in providing inputs for performing a task;
prompt the user to use a second input modality to provide the inputs for performing the task when the first input modality is unsuccessful; and
perform the task based on the inputs received from at least one of the first input modality and the second input modality.

15. A computing system comprising the multimodal interaction system as claimed in claim 7, wherein the computing system is one of a desktop computer, a hand-held device, a multiprocessor system, a personal digital assistant, a mobile phone, a laptop, a network computer, a cloud server, a minicomputer, a mainframe computer, a touch-enabled camera, and an interactive gaming console.

16. A computer program product comprising a computer readable medium, having thereon a computer program comprising program instructions, the computer program being loadable into a data-processing unit and adapted to cause execution of the method according to claim 1 when the computer program is run by the data-processing unit.

17. A computer program adapted to perform the methods in accordance with claim 1.
